(19) United States
(12) Patent Application Publication
(10) Pub. No.: US 2011/0183205 A1
(43) Pub. Date: Jul. 28, 2011

(54) Process for Fabricating a Silicon-Based Electrode, Silicon-Based Electrode and Lithium Battery Comprising Such an Electrode

(75) Inventors: Magdalena Graczyk, Liniewo (PL); Mélanie Alias, Poligny (FR); Sophie Mailley, Le Pin (FR); Sébastien Martinet, Grenoble (FR)

(73) Assignee: Commissariat A L'Energie Atomique Et Aux Engeries Alternatives, Paris (FR)

(21) Appl. No.: 12/919,298

(22) PCT Filed: Feb. 11, 2009
(86) PCT No.: PCT/FR2009/000149

§ 371 Date: Nov. 18, 2010

(30) Foreign Application Priority Data
Feb. 26, 2008 (FR) 0801032

(51) Int. Cl. H01M 4/58; C25D 9/04; B82Y 30/00

(52) U.S. Cl. 429/218.1; 205/316; 977/773; 977/742

(57) ABSTRACT

The invention relates to a process for manufacturing a silicon-based electrode and to a silicon-based electrode. It also relates to a lithium battery comprising such an electrode. The process of the invention consists in fabricating a silicon-based electrode of the type that includes a step of electrochemically depositing silicon on a substrate by cyclic voltammetry in a solution comprising at least one ionic liquid and a silicon precursor of formula SiₙX₂ₙ₊₂, in which x is Cl, Br or I and n is equal to 1 or 2. The electrode of the invention is particularly applicable in the lithium battery field.

The invention relates to a process for manufacturing a silicon-based electrode and to a silicon-based electrode. It also relates to a lithium battery comprising such an electrode.

Most commercial lithium batteries have graphite-based anodes that exchange lithium through an intercalation mechanism.

However, with anodes of this type, the amount of lithium that can be incorporated per weight unit of graphite material is relatively small.

There is a second category of anode materials that are materials capable of incorporating lithium in the form of an alloy, and in particular a silicon alloy.

These silicon-based anodes may often incorporate larger amounts of lithium per unit weight compared to anodes exchanging lithium through an intercalation mechanism.

Thus, V. Baranchugov et al., in “Amorphous silicon thin films as a high capacity anodes for Li-ion batteries in ionic liquid electrolytes”, Electrochemisty Communications 9, 796-800, (2007), describe anodes formed from a support coated with a thin film of amorphous silicon 100 nm in thickness and report a capacity for these electrodes that may be up to 3600 mAhg⁻¹.

However, the electrodes described in that document have relatively poor reversibility and efficiency properties because of their tendency to change volume during lithiation-delithiation cycles. This volume change may degrade the electrical contact between the grains of active material of the anode. The degradation in electrical contact in turn leads to a reduction in capacity, that is to say the amount of lithium that can be incorporated per unit weight of active anode material, over the lifetime of the anode.

In addition, the process described in the above document, that is to say the DC magnetron sputtering of silicon onto the surface of a stainless steel substrate, results in very thin electrodes, which prevents a high capacity per unit area from being achieved.

Specifically, the silicon film has a thickness of 100 nm with a capacity of 50 μAh/cm², which is low. This gives a very high capacity per weight unit of 3000 mAh/g, which cannot be used in lithium-ion batteries that generally have capacities of 320 mAh/g for thicknesses of 300 to 400 μm.

Moreover, a method for electrochemical deposition at constant potential, also called a potentiostatic electrochemical deposition method, is known. This method uses chronoamperometry: a voltage pulse is applied to the working electrode and the change in current over time is recorded. This method is described in particular in the document “Effects of electrochemical-deposition method and microstructure on the capacitive characteristics of nano-sized manganese oxide” by Takuya Shinomiya et al, published in Electrochimica Acta, 51, 4412-4419, (2006), and in the document entitled “High capacitance properties of polyaniline by electrochemical deposition on a porous carbon substrate” by S. K. Mondal et al, published in Electrochimica Acta, 52, 3258-3264, (2007).

Patent application WO 2007/107152 describes a method for obtaining, in particular, semiconductor compounds having diameters in the nanometer range that can be deposited on a substrate, again by the potentiostatic electrochemical deposition method.

However, this potentiostatic electrochemical deposition method does not enable electrode materials for a silicon-based lithium-ion battery to be obtained, for at least three reasons.

The first reason is that the morphology and the electrical capacity of the electrodeposited materials depend strongly on the rate of deposition. Now, potentiostatic deposition promotes instantaneous nucleation followed by three-dimensional (3D Volmer-Weber) growth with quite a long deposition time, of around 60 to 90 minutes. Consequently, the deposited material is compact and homogeneous, sometimes with a lower surface roughness than that of the support. This results in properties that are less interesting in the case of electrochemical applications, in particular in lithium-ion batteries.

The second reason is that the potentiostatic electrodeposition mode leads to the following reaction on the surface of the support:

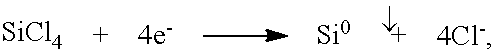

which results in the presence of chloride ions in the pores of the electrodeposited Si film and these chloride ions can react with the lithium and degrade the active material of the battery.

The third reason is that potentiostatic deposition leads to a crystalline structure, as described in the document “Surface analysis of nanoscale aluminium and silicon films made by electrodeposition in ionic liquids” by F. Bebensee et al. However, the amorphous form of the silicon obtained is required for cycling stability of the anode material.

The aim of the invention is to alleviate the drawbacks of the methods of producing electrodes, in particular negative electrodes, for silicon-based lithium-ion batteries of the prior art and provides a method of producing such electrodes that makes it possible to obtain electrodes based on amorphous silicon, of nanoscale size, in which their capacity is very stable over their lifetime and does not result in the presence of chloride ions in the pores of the silicon film.

For this purpose, the invention provides a process for manufacturing a silicon-based electrode, of the type comprising a step of electrochemically depositing silicon on a substrate, characterized in that the electrochemical deposition step is an electrochemical deposition step by cyclic voltammetry in a solution comprising at least one ionic liquid and a silicon precursor of formula SiₙX₂ₙ₊₂, in which X is Cl, Br or I and n is equal to 1 or 2.

Preferably, the silicon precursor has the formula SiₙCl₂ₙ₊₂ in which n is equal to 1 or 2.

More preferably, the silicon precursor is silicon tetrachloride, of formula SiCl₄.

Also preferably, the ionic liquid is chosen from N-butyl-N-methylpyrrolidinium bis(trifluoromethane-sulfonyl)imide, N-ethyl-N,N-dimethyl-N-(2-methoxyethyl)ammonium bis(trifluoromethanesulfonyl)imide and N-methyl-N-propylpiperidinium bis(trifluoromethyl-sulfonyl)imide.

Again preferably, the substrate is made of a conducting material that is stable up to a potential of −4 V relative to a KCl saturated calomel electrode (SCE).

More preferably, the substrate is made of a material chosen from the group formed by copper, nickel, stainless steel, glassy carbon, graphite and composites based on graphite and/or carbon black and/or carbon nanotubes.

Preferably, the substrate is a copper substrate.

The invention also provides an electrode comprising a substrate covered with a silicon film formed from amorphous silicon nanoparticles, which electrode may in particular be obtained by the process for manufacturing an electrode of the invention.

The invention also provides a lithium battery that includes an electrode according to the invention or one obtained by the process of the invention.

The invention will be better understood and other features and advantages thereof will become more clearly apparent on reading the following explanatory description, given in conjunction with the figures in which:

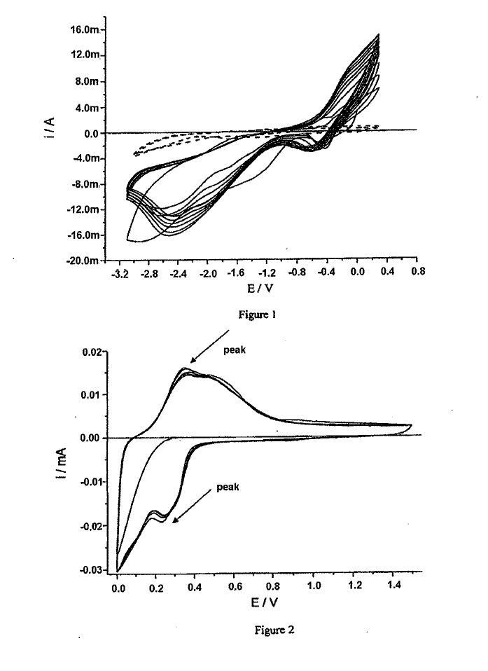

FIG. 1 shows the potential scan curves used for depositing silicon on the surface of a copper substrate, with a potential scan rate of 100 mV/s;

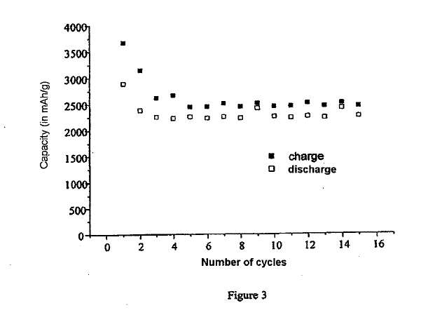

FIG. 2 shows the potential scan curves for a button cell having a lithium metal counterelectrode and, as working electrode, the electrode obtained by the potential scan shown in FIG. 1, with scan rate of 0.1 mV/s; and

FIG. 3 shows the cycling behavior curves for the button cell of FIG. 2 in C/20 galvanostatic mode, that is to say the total theoretical capacity of which is reached in 20 hours, between 0 V and 1.5 V.

The electrochemical deposition by cyclic voltammetry, also called electrochemical potential scan deposition, is a deposition technique enabling a linear potential scan to be imposed as a function of time.

During this deposition, the silicon nucleation mechanism is complex, resembling the growth mechanism referred to as “layer by layer with growth of islands” (3D Stranski-Krastanov). The potential scan promotes silicon nucleation on the surface of the support, thereby making it possible to achieve a high deposition area without loss of roughness relative to the support. Consequently, the highest values of specific capacity and cycling stability of the conducting or semiconducting materials deposited in this way are obtained when they are deposited electrochemically by cyclic voltammetry.

Thus, the process for forming a silicon-based electrode enabling amorphous nanoparticulate silicon used in the invention to be obtained is electrochemical deposition by cyclic voltammetry in a solution of an ionic liquid or a mixture of ionic liquids, this solution also containing a silicon precursor of formula SiₙX₂ₙ₊₂ in which X is Cl, Br or I, more preferably Cl, and n is equal to 1 or 2, preferably n is equal to 1.

The method of electrochemical deposition by cyclic voltammetry makes it possible to deposit the semiconductor, here silicon, at the potential for reduction of the precursor, here SiCl₄, and then to carry out a potential scan toward positive potentials so as to remove the chlorides, releasing chlorine gas. When SiCl₄ is used, the reaction that takes place is the following:

4Cl⁻−4e⁻→2Cl₂↑.

The potential scanning curves used in the process of the invention are shown in FIG. 1. As may be seen in FIG. 1, the silicon reduction and Cl⁻ ion oxidation currents increase from one cycle to another, since the electrodeposited silicon area gradually increases since each cycle deposits a new atomic layer of silicon.

The ionic liquid used in the invention may be any one of the known ionic liquids containing a cation associated with an anion. In other words, the entire family of ionic liquids may be used in the invention.

Among these ionic liquids that may be mentioned are: ionic liquids containing quaternary ammonium ions such as 1-ethyl-3-methylimidazolium, 1-methyl-3-propylimidazolium, 1-methyl-3-isopropylimidazolium, 1-butyl-3-methylimidazolium, 1-ethyl-2,3-dimethylimidazolium, 1-ethyl-3,4-dimethylimidazolium, N-propylpyridinium, N-butylpyridinium, N-tert-butylpyridinium, N-tert-butanolpentylpyridinium, N-methyl-N-propylpyrrolidinium, N-butyl-N-methylpyrrolidinium, N-methyl-N-pentylpyrrolidinium, N-propoxy ethyl-N-methylpyrrolidinium, N-methyl-N-propylpiperidinium, N-methyl-N-isopropylpiperidinium, N-butyl-N-methylpiperidinium, N—N-isobutylmethylpiperidinium, N-sec-butyl-N-methylpiperidinium, N-methoxy-N-ethylmethylpiperidinium and N-ethoxyethyl-N-methylpiperidinium ions.

Mention may also be made of ionic liquids containing ammonium ions such as butyl-N—N—N—N-trimethylammonium, N-ethyl-N—N-dimethyl-N-propylammomium, N-butyl-N-ethyl-N—N-dimethylammonium and butyl-N—N—N-dimethyl-N-propylammonium ions, these being associated with any anion, such as anions from the groups composed of tetrafluoroborate (BF₄), hexafluorophosphate (PF₆), bis(trifluoromethane sulfonyl)amide (TFSI) or bis(trifluorosulfonyl)amide (FSI) anions.

Preferably, in the invention the ionic liquid is N-butyl-N-methylpyrrolidinium bis(trifluoromethane-sulfonyl)imide or N-ethyl-N,N-dimethyl-N-(2-methoxy-ethyl)ammonium bis(trifluoromethanesulfonyl)imide or else N-methyl-N-propylpiperidinium bis(trifluoromethyl-sulfonyl)imide.

In the invention, the silicon is electrochemically deposited by cyclic voltammetry on a substrate that acts as working electrode during silicon deposition and as support for the silicon film formed in the electrode obtained by the invention.

The materials for the substrate may be chosen from the following nonexhaustive list: copper, nickel, stainless steel, graphite, carbon black, glassy carbon or composites with or without a binder based on graphite and/or carbon black, such as for example a copper foil coated with carbon black or with carbon nanotubes.

The essential point is that the substrate is a conducting material stable up to a potential of −4 V relative to a KCl-saturated calomel electrode.

Preferably, the substrate will have a high specific surface area on the side on which the silicon is electrodeposited, this specific surface area being that obtained naturally or obtained artificially, for example using abrasive paper. This is why composites are preferred since they naturally have a high specific surface area of around 2 m²/g, this being sufficient to obtain satisfactory deposits with a specific surface area of 250 cm² per projected cm².

This high specific surface area of the substrate thus makes it possible to obtain a deposit with a large active area, thereby resulting in a large surface area of deposited materials. The method of electrochemically depositing silicon by cyclic voltammetry makes it possible to obtain a homogeneous silicon deposit on a large area, and therefore with a high capacity.

The specific surface area of a composite is calculated from the specific surface areas of the individual components, for example those supplied by the company TIMCAL.

To make the invention more clearly understood, several methods of implementation and embodiments thereof will now be described. These examples are given merely to illustrate the invention and must in no way be considered as limiting the scope of the invention.

### EXAMPLE 1

The substrate was a copper foil 4 cm² in area.

The deposition solution consisted of an ionic liquid, namely N-butyl-N-methylpyrrolidinium bis (trifluoromethanesulfonyl)imide with the reference P14TFSI, sold by Solvionic, with a purity of 99.99%, saturated with 99.9% pure SiCl₄ sold by Aldrich.

Silicon was deposited in a glass cell having three electrodes, with a platinum wire as counterelectrode and a platinum wire in the ionic liquid placed in a compartment separated by a glass frit, as quasi-reference electrode.

The potential of the ferrocene/ferricenium redox pair, denoted by Fc/Fc⁺, in the solution of the ionic liquid relative to this electrode was 500 mV.

This ferrocene/ferricenium redox pair was also used as reference when it was not possible to use a KCl-saturated calomel electrode. It had a potential of 0.4 V relative to an SCE.

All the operations were carried out in a glovebox containing less than 1 ppm of O₂ and H₂O. The ionic liquid was vacuum-dried at 80° C. for 12 hours and then the electrochemical deposition was carried out by cyclic voltammetry using a 50 mV/s scan rate starting from 0 V and going on down to −3.2 V, and then applying a scan toward the positive potential up to 0.3 V. The VoltaLab 50 potentiostat (PST050) was used to control the potential.

To obtain a silicon film about 30 nm in thickness, at least fifteen scan cycles were necessary, as shown in FIG. 1.

The silicon film formed in this way was rinsed several times with isopropanol so as to remove the residual ionic liquid and the residual silicon tetrachloride. The film was then vacuum-dried at room temperature for one hour.

The copper foil coated with the 30 nm thick silicon film was cut into disks 14 mm in diameter, i.e. with an area of 1.54 cm². A silicon-based electrode consisting of a substrate coated with a 30 nm silicon film was obtained.

Electrochemical cells of the “button cell” type were assembled with lithium metal as negative electrode, a microporous separator, this being a commercial polymer Celgard®, using, as electrolyte, the ionic liquid N-butyl-N-methylpyrrolidinium bis(trifluoromethane sulfonyl)imide used to deposit the silicon, plus lithium bis(trifluoromethanesulfonyl)imide, LiTFSI, and the copper foil with its deposited silicon film as positive electrode. LiTFSI, as sold by 3M, had purity of 99%.

This system was tested in cyclic voltammetry using a multipotentiostat (Biologic VMP system). The scan rate was 0.1 mV/s. FIG. 2 shows the potential scan curves obtained with this button cell.

As may be seen in FIG. 2, the electrochemical behavior is very stable. The two peaks characteristic of lithium deinsertion at the anode do not change over the course of the cycle.

After five scan cycles, the cell was then tested in C/20 galvanostatic mode between 0 V and 1.5 V.

The curves showing the cycling behavior of the button cell obtained in this example is shown in FIG. 3.

As may be seen in FIG. 3, the capacity of the button cell obtained is constant, both in charge mode and in discharge mode over more than fifteen cycles.

### EXAMPLE 2

The substrate was a copper foil 4 cm² in area used as working electrode for depositing the silicon.

The silicon was deposited by cyclic voltammetry in a glass cell having three electrodes, with a platinum wire as counterelectrode and a platinum wire in the ionic liquid, which consisted of N-ethyl-N,N-dimethyl-N-(2-methoxyethyl)ammonium bis(trifluoromethane-sulfonyl)imide (99.99% pure EDMMEATFSI from Solvionic) and containing, as silicon precursor, 99.9% pure silicon tetrachloride SiCl₄ sold by Aldrich.

The platinum wire in the EDMMEATFSI ionic liquid was placed in the compartment separated by a glass frit as quasi-reference electrode. The Fc/Fc⁺ potential in the solution of the ionic liquid relative to this electrode was 550 mV.

The deposition solution consisted of the SiCl₄-saturated ionic liquid. All the operations were carried out in a glovebox in atmosphere containing less than 1 ppm of O₂ and of H₂O.

The ionic liquid was vacuum-dried at 80° C. for 12 h prior to electrochemical deposition. The electrochemical deposition was carried out by means of the cyclic voltammetry technique, with a scan rate of 50 mV/s, the scan starting at 0 V and then descending to −3.2 V, and then a scan toward the positive potential up to 0.3 V.

A VoltaLab 50 (PST050) potentiostat was used to control the potential.

To deposit a silicon film about 30 nm in thickness, fifteen scan cycles were required. The silicon film formed in this way was rinsed several times with isopropanol so as to remove the residual ionic liquid and the residual silicon tetrachloride, and then vacuum-dried at room temperature for 1 h.

The copper foil was cut into disks with a diameter of 14 mm (1.54 cm² area). Electrochemical cells of the “button cell” type were assembled with lithium metal as negative electrode, a microporous separator and an LP100 electrolyte. The LP100 electrolyte was a commercial Merck electrolyte, consisting of 1 mol/l of LiPF₆ (lithium hexafluorophosphate) in EC/PC/DMC (ethylene carbonate/propylene carbonate/dimethyl carbonate in 1/1/3 by weight) and, as positive electrode, the silicon-coated copper disk obtained in this example. The system was tested in cyclic voltammetry using a multipotentiostat (Biologic VMP system).

The same curves as shown in FIG. 2 were obtained.

### EXAMPLE 3

In this example, the substrate was a sheet made of a composite consisting of:
MCMB2528 graphite, i.e. mesocarbon microbeads, this being a material consisting of graphite fibers and natural and artificial carbon used by lithium batteries, supplied by the company Osaka Gas;
carboxymethylcellulose (CMC);
NBR, i.e. an aqueous solution of Perbunan-N-Latex, supplied by Polymer Latex GmbH, as binder; and
Tenax®+SFG6® fibers supplied by the company TIMCAL, as electron conductor, coated on a copper foil.

This sheet served as working electrode for depositing silicon in order to form the electrode according to the invention. The geometric area of the sheet used for the deposition was 4 cm². The composite working electrode described above was vacuum-dried for 24 h at 80° C. before the silicon deposition. The silicon was deposited in a glass cell having three electrodes, with a platinum wire as counterelectrode and a platinum wire in the ionic liquid, which was N-ethyl-N,N-dimethyl-N-(2-methoxyethyl)ammonium bis(trifluoromethane-sulfonyl)imide (99.99% pure EDMMEATFSI from Solvionic) placed in the compartment separated by the glass frit as quasi-reference electrode. The Fc/Fc⁺ potential in the ionic liquid solution relative to this electrode was 550 mV.

The deposition solution consisted of the ionic liquid saturated with 99.9% SiCl₄ (from Aldrich).

All the operations associated with silicon deposition and with the production of electrochemical cells of the button cell type were carried out in a glovebox containing an atmosphere having less than 1 ppm of O₂ and H₂O. The ionic liquid was vacuum-dried at 80° C. for 12 h before the electrodeposition.

The silicon was electrochemically deposited in this cell by cyclic voltammetry, with a scan rate of 20 mV/s, the scan starting at 0 V and descending to −3.2 V, followed by a scan toward the positive potential up to 0.3 V. A VoltaLab 50 (PST050) potentiostat was used to control the potential.

Fifteen scan cycles were required to deposit a silicon film 30 nm in thickness. The silicon film was rinsed several times with isopropanol so as to remove the residues of ionic liquid and of silicon tetrachloride, and then vacuum-dried at room temperature for 1 h.

The composite electrode formed in this way was cut into disks 14 mm in diameter, i.e. having a projected or geometric area of 1.54 cm². Electrochemical cells of the “button cell” type were assembled with lithium metal as negative electrode, the microporous separator, the LP100 electrolyte and the silicon-coated composite electrode as positive electrode. This system was tested in cyclic voltammetry using a multipotentiostat (Biologic VMP system).

The capacity of the button cell obtained was again constant and stable, as in the previous examples.

The benefit of the invention is not so much in obtaining a high capacity (Baranchugov gives the maximum theoretical limits in the case of Si) but rather in obtaining suitable capacities in whatever the material on which the silicon is deposited and without any thickness limitation of the silicon film obtained.

Thus, for a thickness of 100 nm on a composite with an area of 250 cm²/cm², a capacity of 12.5 mAh/cm² was obtained instead of 50 μAh/cm², this being very promising for lithium-ion batteries.

Indeed, the deposition method of the invention makes it possible to deposit a controlled thickness of material that maintains the same properties throughout its thickness, in particular its amorphous character, thereby resulting in a high level of reversibility of the material during operation of the battery.

Thus, the method of producing an anode according to the invention enables silicon-based electrodes to be formed that have a good lifetime and a constant capacity over its lifetime.

The electrode of the invention is therefore formed from a support coated with an amorphous silicon film having a high specific surface area. It has a stable capacity, of about 2300 mAh/g.

The electrode of the invention is particularly appropriate for manufacturing lithium batteries.

It will be clearly apparent to those skilled in the art that, although in the examples given silicon tetrachloride was used as silicon precursor, any other silicon precursor of formula SiₙX₂ₙ₊₂ in which X represents a halogen, such as chlorine, iodine or bromine and n is equal to 1 or 2, may be used.

1. A process for manufacturing a silicon-based electrode, of the type comprising a step of electrochemically depositing silicon on a substrate, characterized in that the electrochemical deposition step is an electrochemical deposition step by cyclic voltammetry in a solution comprising at least one ionic liquid and a silicon precursor of formula SiₙX₂ₙ₊₂, in which X is Cl, Br or I and n is equal to 1 or 2.

2. The process as claimed in claim 1, in which the silicon precursor has the formula SiₙCl₂ₙ₊₂ in which n is equal to 1 or 2.

3. The process as claimed in claim 1, characterized in that the silicon precursor is silicon tetrachloride of formula SiCl₄.

4. The process as claimed in claim 1, characterized in that the ionic liquid is chosen from N-butyl-N-methylpyrrolidinium bis(trifluoromethanesulfonyl)imide, N-ethyl-N,N-dimethyl-N-(2-methoxyethyl)ammonium bis(trifluoromethanesulfonyl)imide and N-methyl-N-propylpiperidinium bis(trifluoromethylsulfonyl)imide.

5. The process as claimed in claim 1, characterized in that the substrate is made of a conducting material that is stable up to a potential of −4 V relative to a KCl saturated calomel electrode.

6. The process as claimed in claim 1, characterized in that the substrate is made of a material chosen from the group formed by copper, nickel, stainless steel, glassy carbon, graphite and composites based on graphite and/or carbon black and/or carbon nanotubes.

7. The process as claimed in claim 1, characterized in that the substrate is a copper substrate.

8. An electrode of the type comprising a substrate covered with a silicon film, which electrode can be obtained by the process as claimed in claim 1, characterized in that the silicon film is formed from amorphous silicon nanoparticles.

9. A lithium battery, characterized in that it includes an electrode as claimed in claim 8.
